(19) United States
(12) Patent Application Publication
(10) Pub. No.: US 2018/0236847 A1
(43) Pub. Date: Aug. 23, 2018

(54) POROUS FUEL TREATMENT ELEMENT

(71) Applicant: WEBASTO SE, Stockdorf (DE)

(72) Inventors: KLAUS MOESL, Stockdorf (DE); BENGT MEIER, Stockdorf (DE); PETER NEIDENBERGER, Stockdorf (DE); VITALI DELL, Stockdorf (DE)

(21) Appl. No.: 15/742,239

(22) PCT Filed: Jun. 16, 2016
(86) PCT No.: PCT/DE2016/100270

§ 371 Date: Jan. 5, 2018

(30) Foreign Application Priority Data
Jul. 6, 2015 (DE) 10 2015 110 829.1

(51) Int. Cl. B60H 1/22; F23D 5/10; F23D 5/12

(52) U.S. Cl. CPC B60H 1/2203; F23D 5/10; B60H 2001/2284; B60H 2001/2271; F23D 5/12

(57) ABSTRACT

A porous fuel treatment element (5) for an evaporation burner is provided, said porous fuel treatment element (5) having at least one first tier (8) of a textile planar structure which is formed from a plurality of fibers. The fibers in the first tier (8) comprise at least two different fiber types (10, 11) which differ in terms of the material, of the cross-sectional profile, of the surface structure, and/or of the thickness.

The present invention relates to a porous fuel treatment element for an evaporation burner, said fuel treatment element having at least one tier of a textile planar structure which is formed from a plurality of fibers.

Apart from atomizing burners which are likewise used to some extent, evaporation burners in which the liquid fuel is evaporated, subsequently treated with supplied combustion air so as to form a fuel/air mixture, and subsequently reacted in an exothermal reaction, are often used in the case of mobile heating apparatuses that are operated using liquid fuel, such as are used in particular as stationary vehicle heaters or auxiliary heaters in vehicles. In particular in the case of a use in vehicles, the fuel that is also utilized for operating the internal combustion engine of the vehicle, in particular for example diesel, gasoline, ethanol, and similar, is often used as the liquid fuel.

The liquid fuel in evaporation burners of this type is usually first supplied to a porous fuel treatment element which serves for storing, distributing, and evaporating the fuel. In particular, a plurality of porous fuel treatment elements which, for example, are in each case adapted to these various functions, can also be provided.

WO 2012/155897 A1 describes an evaporator assembly for an evaporation burner for a mobile heating apparatus, in which an evaporation element has at least one layer from a woven metal fabric from interwoven metal wires. It is furthermore described that a multi-tiered construction in which a layer from a woven metal fabric is combined with a further layer from a non-woven metal fabric is provided, for example.

It is an object of the present invention to provide an improved porous fuel treatment element for an evaporation burner, in which the desired properties of the fuel treatment element can in particular be set in an even more targeted manner.

The object is achieved by a porous fuel treatment element for an evaporation burner as claimed in claim 1. Advantageous refinements are set forth in the dependent claims.

The porous fuel treatment element has at least one first tier of a textile planar structure which is formed from a plurality of fibers. The fibers in the first tier comprise at least two different fiber types which differ in terms of the material, of the cross-sectional profile, of the surface structure, and/or of the thickness. Consequently, at least two different fiber types have to be present; however it is also possible for more than two different fiber types to be provided, for example. At least one tier of the porous fuel treatment element is thus a mixed textile product which is composed of different fiber types. The fibers of the textile planar structure herein can be formed, for example, by individual filaments (or, for example, individual metal wires), or else, for example, can in each case also have a plurality of individual filaments (present for example as a strand, a twisted yarn, a rope, or a multifilament). In the latter case, different individual filaments, for example, can also differ from one another in terms of the material thereof, for example. The different fiber types differ from one another in terms of at least one of the following features: material, cross-sectional profile, surface structure, thickness. However, it is also possible for the fibers to differ from one another in terms of a plurality of these features, for example. The desired properties of the porous fuel treatment element can be set in a particularly targeted manner by the combination of at least two different fibers in the same tier of the porous fuel treatment element, in particular in a substantially more targeted manner than in the case of a construction of the fuel treatment element from different tiers in which a uniform fiber type is present in each of the individual layers and in which the fibers differ from one another only from one tier to the next tier. The first tier herein can be disposed at various positions in the porous fuel treatment element, in particular on a side that faces the combustion space for example, on a side that faces away from the combustion space, or between other tiers.

The textile planar structure can be a felt, a non-woven fabric, a needled mat, a scrim, a woven fabric, a warp/weft-knitted fabric, a knitted fabric, or a braided fabric. For example, it is also possible for the fuel treatment element to have a plurality of tiers which are formed by different textile planar structures such as is the case, for example, in a combination of a woven fabric and a non-woven fabric, in a combination of a knitted fabric with a woven fabric, etc. In this way, the properties of the fuel treatment element can be set in a targeted manner to the desired functions also in spatial terms, for example.

According to one refinement, the fibers of the at least one tier comprise at least two different materials. In this case, the properties of the tier can be set in a simple manner, for example by modifying the proportions of the different materials. The different materials herein can be present in such a manner, for example, that one part of the fibers is composed of a first material, another part of the fibers is composed of a second material, and these two fiber types are conjointly processed, for example by knitting, weaving, cross-laying, etc. so as to form a textile planar structure. However, on the other hand, for example, it is also possible for the individual fibers of the textile planar structure per se to already be formed as a combination of two or more materials, for example as a multifilament which has individual filaments from different materials. For example, the different materials can belong to the same material classification, such as, for example, be two or more different types of metal, types of steel, for example, or else also belong to different material classes, for example, such as is the case, for example, in a combination of one or a plurality of metals and one or a plurality of other materials.

According to one refinement, at least one fiber type is composed of a plurality of individual filaments. In this case, the properties of the tier can already be set by way of the configuration of the fiber type and optionally by way of the use of different individual filaments for the at least one fiber type. The fibers of the at least one fiber type can be configured, for example, as a strand, as a twisted yarn, as a rope, or as a multifilament or roving, respectively. The plurality of individual filaments can preferably comprise at least two different materials.

According to one refinement, at least one fiber type comprises metal wire. In this case, a good thermal stability and a high thermal conductivity can be provided in a reliable manner. For example, one or a plurality of fiber types can also be formed by metal wire. Steel wire in particular can be used as metal wire. Furthermore, for example, two different metal wires, in particular steel wires, can also be used, said metal wires potentially having, for example, a different cross-sectional shape and/or potentially comprising different steel types. For example, a flat wire of one steel type can be combined with a round wire of another steel type, or similar. Furthermore for example, metal wire, in particular steel wire, can be combined with another fiber type, in particular with, for example, rock fiber, preferably basalt fiber, glass fiber, ceramic fiber, and/or a synthetic fiber.

According to one refinement, at least one fiber type comprises glass fiber, rock fiber, synthetic fiber, or ceramic fiber. In this case, a thermal conductivity of the thermal treatment element that is reduced in comparison to a fuel treatment element which is composed of only metal fibers or wires, respectively, can be provided in a particularly reliable manner.

According to one design embodiment, the at least one fiber type comprises rock fiber. The fiber type herein can preferably comprise in particular basalt fiber, particularly preferably be formed from basalt fiber. The use of rock fiber on its own or in a combination with, for example, another fiber type, in particular with metal wire, enables a particularly good setting of the properties of the fuel treatment element. Basalt fibers in particular are distinguished by a high thermal stability and fire resistance, and have a good resistance to chemicals and a high resistance to corrosion as well as a high level of UV stability. Moreover, basalt fibers are distinguished by good vibration damping which enables an improvement in the acoustic properties of the evaporation burner. Furthermore, in particular the relatively low thermal conductivity and the high electrical resistance of basalt fibers can be advantageously utilized for the fuel treatment element, for example in particular when combined with metal wire which to some extent has opposing properties.

According to one preferred design embodiment, the at least two fiber types can comprise at least metal wire and at least one of glass fiber, rock fiber, synthetic fiber, and ceramic fiber. On account of the combination of to some extent opposing properties of these materials, the properties of the fuel treatment element can be set in a particularly advantageous manner.

According to one refinement, the porous fuel treatment element comprises at least one further tier of a textile planar structure which in terms of the construction, of the structure, of the material, and/or of the thickness differs from the first tier. In this case, the properties of the fuel treatment element can be set both in the individual tiers as well as additionally by way of the design of the sequence of a plurality of tiers. For example, the at least one further tier can be configured in the various variants which have been described above in the context of the first tier. Furthermore, the at least one tier can in particular also be embodied in the conventional manner as a non-woven metal fabric, a woven metal fabric, a warp/weft-knitted metal fabric, as a knitted metal fabric, as a ceramic body, or similar. In particular, a plurality of further tiers can also be provided. In turn, such further tiers can also provide the same properties or specially selected other properties, for example.

According to one refinement, the fibers of the at least one further tier also comprise at least two different fiber types which differ in terms of the material, of the cross-sectional shape, of the structure, and/or of the thickness. In this case, the properties of the fuel treatment element can be predefined very precisely in a simple manner.

According to one refinement, the fibers in the first tier comprise at least fibers having a first cross-sectional shape and fibers having a second cross-sectional shape. For example, the fibers having the first cross-sectional shape can be formed by metallic flat wire (or optionally wire having another angular, roughened or similar cross-sectional shape), and the fibers having the second cross-sectional shape can be formed by metallic round wire, for example. The fibers herein can comprise the same material, for example, a specific steel type, for example, or else be formed from different materials, in particular from two different steel types, for example.

According to one refinement, a mobile heating apparatus having an evaporation burner which has a porous fuel treatment element as claimed in one of the preceding claims is provided. A mobile heating apparatus in the present context is understood to be a heating apparatus which is conceived for the use in mobile applications and is accordingly adapted. This means in particular that said heating apparatus is transportable (optionally being fixedly installed in a vehicle or being accommodated in said vehicle exclusively for transportation) and is not conceived exclusively for a permanent stationary use such as is the case, for example, when heating a building. The mobile heating apparatus herein can also be fixedly installed in a vehicle (land transportation vehicle, ship, etc.), in particular in a land transportation vehicle. Said mobile heating apparatus can be conceived in particular for heating a vehicle interior such as of, for example, a land, water, or air transportation vehicle, and a partially open space such as can be found, for example, on ships, in particular yachts. The heating apparatus can also be used in a temporarily stationary manner such as, for example, in large tents, containers (for example portable cabins on construction sites), etc. The mobile heating apparatus can in particular be conceived as a stationary vehicle heater or auxiliary heater for a land transportation vehicle such as, for example, for a caravan, a mobile home, a bus, a passenger car, etc.

Further advantages and refinements are derived from the description hereunder of exemplary embodiments with reference to the appended drawings in which:

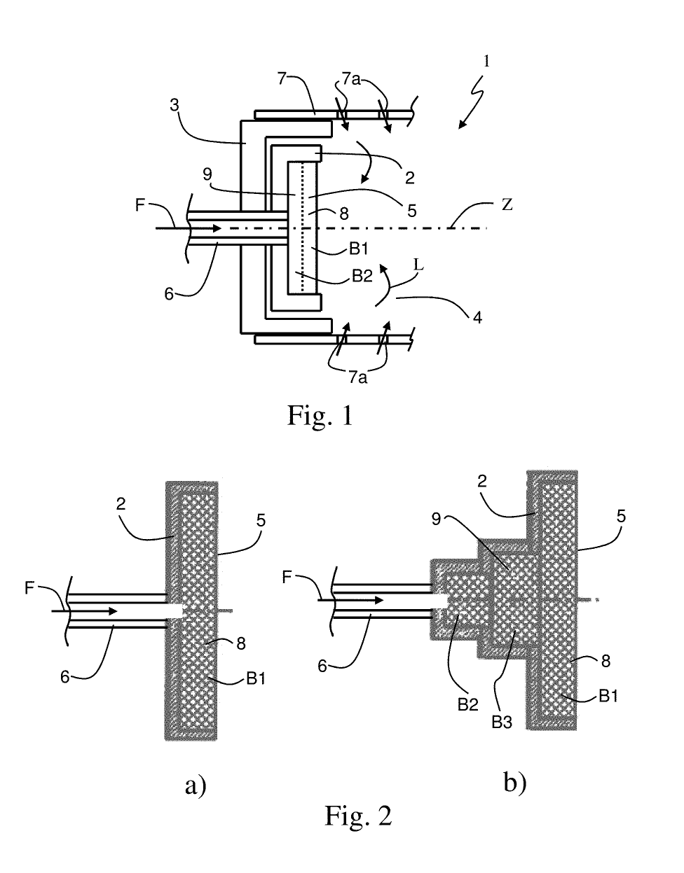

FIG. 1 shows a schematic illustration of part of an evaporation burner having a porous fuel treatment element in a mobile fuel-operated heating apparatus according to one embodiment;

FIG. 2a) shows a schematic illustration of an evaporator receptacle having a fuel treatment element according to a first modification of the embodiment;

FIG. 2b) shows a schematic illustration of an evaporator receptacle having a fuel treatment element according to a second modification of the embodiment;

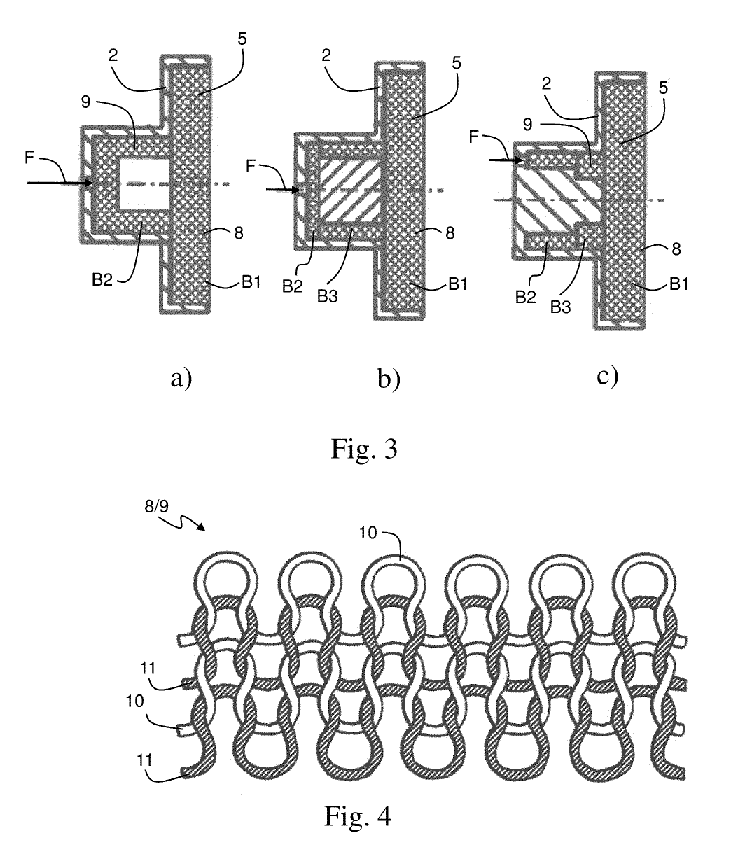

FIG. 3a) shows a schematic illustration of an evaporator receptacle having a fuel treatment element according to a third modification of the embodiment;

FIG. 3b) shows a schematic illustration of an evaporator receptacle having a fuel treatment element according to a fourth modification of the embodiment;

FIG. 3c) shows a schematic illustration of an evaporator receptacle having a fuel treatment element according to a fifth modification of the embodiment;

FIG. 4 shows a schematic illustration of a first example of a tier of a textile planar structure in a fuel treatment element;

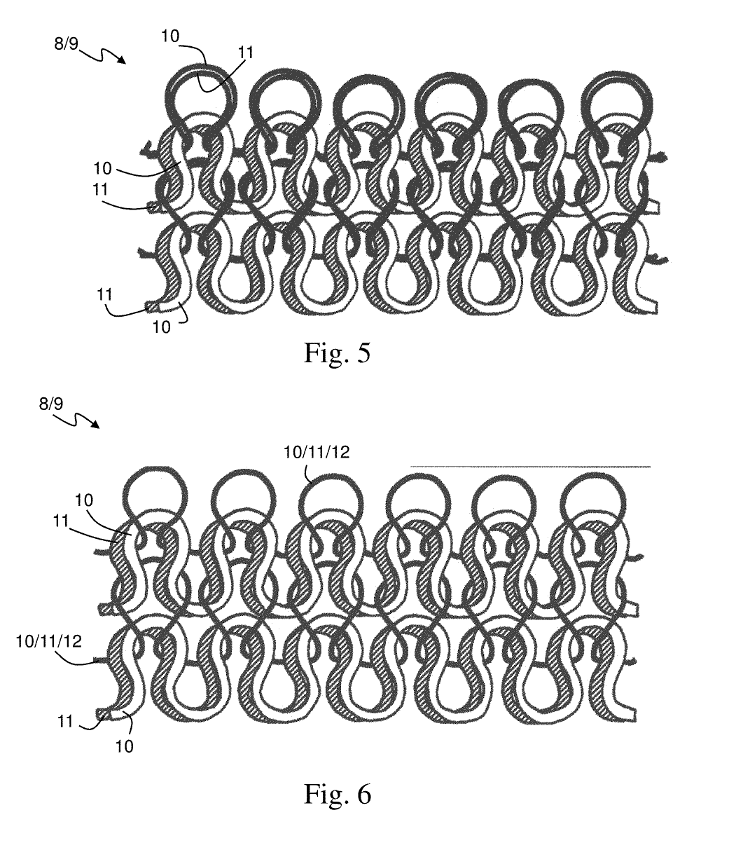

FIG. 5 shows a schematic illustration of a second example of a tier of a textile planar structure in a fuel treatment element;

FIG. 6 shows a schematic illustration of a third example of a tier of a textile planar structure in a fuel treatment element;

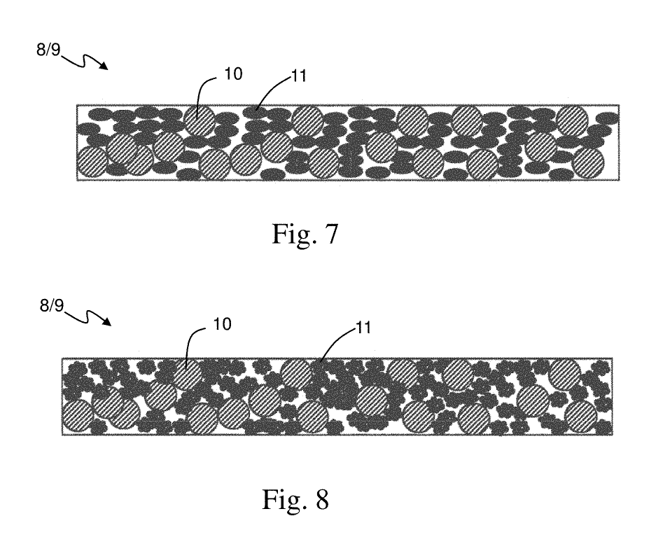

FIG. 7 shows a schematic illustration of a cross section through a tier of a textile planar structure in one example;

FIG. 8 shows a schematic illustration of a cross section through a tier of a textile planar structure in another example.

### EMBODIMENTS

A first embodiment will be described in more detail hereunder with reference to FIG. 1.

A region of an evaporator receptacle 2 and of a burner lid 3 of an evaporation burner 1 for a mobile heating apparatus is schematically illustrated in FIG. 1. FIG. 1 is a schematic illustration in a plane that includes a main axis Z of the evaporation burner. The evaporation burner can be substantially rotationally symmetrical in relation to the main axis Z, for example. The evaporation burner 1 can be configured for a vehicle heating apparatus, for example, in particular an auxiliary heater or a stationary vehicle heater. The evaporation burner 1 herein is configured in particular for converting a mixture of evaporated fuel and combustion air, thus a fuel/air mixture, in a combustion chamber 4, while releasing heat. The conversion herein can be performed in particular in a flame-generating combustion, but a partially or fully catalytic conversion is also possible. The released heat in a heat exchanger (not illustrated) is transmitted to a medium to be heated, which can be formed by air or a coolant liquid, for example. Not illustrated in the schematic illustration of FIG. 1 are in particular the heat exchanger, the discharge for the hot combustion exhaust gases, the combustion-air conveying device (for example a blower) that is likewise provided, the fuel conveying device (for example a metering pump), the control unit for actuating the evaporation burner, etc. These components are well-known and are described in detail in the prior art.

The evaporation burner 1 has an evaporator receptacle 2 in which a porous fuel treatment element 5 is disposed. The evaporator receptacle 2 in the case of the exemplary embodiment is substantially pot-shaped. The fuel treatment element 5 is received in the pot-type depression of the evaporator receptacle 2 and in particular can be fixedly held in the latter, for example by welding, brazing/soldering, jamming, or with the aid of a suitable securing element. The design embodiment of the fuel treatment element 5 will be described in even more detail hereunder.

A fuel supply line 6 for supplying liquid fuel to the fuel treatment element 5 is provided. The fuel supply line 6 opens into the evaporator receptacle 2 and is connected to a fuel conveying device (not illustrated) by way of which liquid fuel in a predefined quantity can be conveyed through the fuel supply line 6, as is schematically illustrated by an arrow F. The fuel supply line 6 is fixedly connected to the evaporator receptacle 2, for example by welding or brazing/soldering.

The combustion space 4 on the circumference is delimited by a combustion chamber 7 which can be formed, for example, by a substantially cylindrical component from a temperature-resistant steel. The combustion chamber 7 is provided with a plurality of bores 7a by way of which the combustion air can be supplied to the combustion space 4, as is schematically illustrated by arrows in FIG. 1. The bores 7a herein are part of a combustion air supply L by way of which the combustion air is supplied to a side of the fuel treatment element 5 that faces away from the fuel supply line 6.

The evaporation burner 1 is configured in such a manner that in operation liquid fuel can be supplied by way of the fuel supply line 6 to the fuel treatment element 5. On the one hand, on account of a multiplicity of cavities, a distribution of the fuel across the entire width of the fuel treatment element 5 is performed in and on the fuel treatment element 5, and an evaporation or volatization, respectively, is performed on that side that faces the combustion space 4, on the other hand. In the case of the embodiment illustrated, the fuel treatment element 5 has a substantially circular cross-sectional shape, the main axis Z of the evaporation burner 1 running in the center of said circular cross-sectional shape. However, the fuel treatment element 5 can also have other cross-sectional shapes.

The combustion burner 1 is configured in such a manner that an evaporation or volatization, respectively, of the liquid fuel is performed in the fuel treatment element 5 and on the surface of the latter, the evaporated fuel being mixed with the supplied combustion air so as to form a fuel/air mixture only when exiting from the fuel treatment element 5, that is to say at the side of the combustion space. The supply of liquid fuel and combustion air is thus performed on different sides of the fuel treatment element 5. The conversion of the fuel/air mixture in an exothermal reaction herein does not take place in the fuel treatment element 5 but in the downstream combustion space 4. In the operation of the evaporation burner 1 there is thus liquid fuel and fuel vapor in the fuel treatment element 5, and any air that is potentially initially present is forced out of the fuel treatment element 5 by virtue of the evaporation or volatization process, respectively.

In the case of the exemplary embodiment schematically illustrated in FIG. 1, the fuel treatment element 5 has a construction with a plurality of functional regions, said construction in the example specifically illustrated being subdivided into a first region B1 and into a second region B2, the latter having a structure that deviates from the structure in the first region B1. The second region B2 in the case of the exemplary embodiment is disposed so as to face the fuel supply line 6, and the first region B1 is disposed so as to face the combustion space 4.

In the case of the first modification of the embodiment schematically illustrated in FIG. 2a), the fuel treatment element 5 does not have a plurality of different functional regions, there rather being only one first region B1.

In the case of the second modification of the embodiment schematically illustrated in FIG. 2b), the fuel treatment element 5 has a stepped design with a total of three regions B1, B2, B3, and the evaporator receptacle 2 is configured in a corresponding manner. In such a case, the different regions B1, B2, B3 can be concealed in a targeted manner with a view to the various functions of the fuel treatment element 5, for example. For example, the second region B2 can be optimized for conveying fuel by way of capillary forces and for temporarily storing fuel, the third region B3 can be optimized with a view to a distribution of fuel in the transverse direction and serve for compensating tolerances, and the first region B1 can be optimized with a view to the evaporation or volatization, respectively, of fuel. The different regions B1, B2, B3 herein can differ from one another in particular in terms of their construction, the structure, the material, and/or the thickness or the height and/or the diameter, etc. thereof. The respective fiber types herein can also differ from one another in terms of their material, the cross-sectional profile, the surface structure, and/or the thickness thereof, for example.

Further potential design embodiments of fuel treatment elements 5 having a plurality of functional regions B1, B2, B3 are schematically illustrated in FIGS. 3a, 3b, and 3c. While the fuel supply line 6 and further components are again not illustrated in FIGS. 3a, 3b, and 3c, it is understood that these further components are also present in the case of each of these further modifications.

The construction of the fuel treatment element 5 as can be used in the case of the embodiment and the modifications described above will be described in more detail hereunder. The design embodiment herein described hereunder can be used for each one of the regions B1, B2, and B3.

In the case of the embodiment and the modifications thereof, the porous fuel treatment element 5 has in each case at least one first tier 8 of a textile planar structure which is formed from a plurality of fibers. The textile planar structure herein can be a felt, a non-woven fabric, a needled mat, a scrim, a woven fabric, a warp/weft-knitted fabric, a knitted fabric, or a braided fabric. At least this first tier 8 of a textile planar structure has the peculiarity that the fibers in the first tier 8 comprise at least two different fiber types which differ in terms of the material, the cross-sectional profile, the surface structure, and/or the thickness. The individual fibers herein from which the first tier 8 is formed can in each case be individual filaments, for example, or can in turn per se again be composed from a plurality of individual filaments, for example, such as is the case with a roving, a strand, or similar, for example. A region B1, B2, B3 of the fuel treatment element 5 can be constructed in a single tier manner, for example, in particular by way of only the first tier 8 of the textile planar structure, or else have a multi-tiered construction having a plurality of tiers. In the case of a multi-tiered construction, the different tiers can be of the same type or else also differ from one another in terms of at least one property, for example.

When the porous fuel treatment element 5 has a plurality of tiers (either within the same region B1, B2, or B3, or in different ones of the regions B1, B2, or B3), said porous fuel treatment element 5 can in particular have a further tier 9 of a textile planar structure, said further tier 9 differing from the first tier 8 in terms of the construction, the structure, the material, and or the thickness. The textile planar structure of the further tier 9 herein can again be a felt, a non-woven fabric, a needled mat, a scrim, a woven fabric, a warp/weft-knitted fabric, a knitted fabric, or a braided fabric.

The construction of the first tier 8 of the textile planar structure (and optionally also of a further tier 9 of a textile planar structure) in the case of the embodiment and the modifications thereof will be explained in more detail hereunder by means of examples.

### EXAMPLE 1

A first example of a construction of the first tier 8 (or of a second tier 9, respectively) of a textile planar structure will be described with reference to FIG. 4.

In the case of the first example schematically illustrated in FIG. 4, the tier 8 or 9, respectively, of the textile planar structure is formed by a knitted fabric from two different fiber types 10, 11 that are interknitted in an alternating manner. The tier 8 or 9, respectively, thus comprises a first fiber type 10 and a second fiber type 11, respectively, said fiber types 10, 11 differing from one another in terms of at least one property. In the case of the specific example, the first fiber type 10 is formed by metal wire, for example, and the second fiber type 11 is formed by glass fiber, rock fiber, synthetic fiber, or ceramic fiber. In the case of one preferred design embodiment, the second fiber type 11 is formed in particular by basalt fiber as a specific type of rock fiber.

Alternatively to this specific design embodiment set forth, it is also possible, for example, for both the first fiber type 10 as well as the second fiber type 11 to be formed from steel wire, for example, wherein different steel types are used for the first fiber type 10 and for the second fiber type 11, and/or the cross-sectional shape is different.

### EXAMPLE 2

A second example of a construction of the first tier 8 (or of a second tier 9, respectively) of a textile planar structure will be described with reference to FIG. 5.

In the case of the second example schematically illustrated in FIG. 5, the tier 8 or 9, respectively, of the textile planar structure is also formed by a knitted fabric. However, by contrast to the first example described above, the two fiber types 10, 11 in the case of the second example are interknitted in such a manner that said fiber types 10, 11 in all loops are guided so as to be continuously mutually parallel and do not alternate from one loop to another.

### EXAMPLE 3

A third example of a construction of the tier 8 or 9, respectively, of a textile planar structure will be described with reference to FIG. 6.

In the case of the third example schematically illustrated in FIG. 6, the tier 8 or 9, respectively, of the textile planar structure is also formed by a knitted fabric. However, by contrast to the examples described above, two different fiber types 10, 11 are guided so as to be continuously mutually parallel only in the case of each second loop. The respective interdisposed loop can be formed by one of the two fiber types 10, 11, for example, or else by a third fiber type 12, for example. Alternatively to the specific design embodiment set forth, it is also possible for the first fiber type 10 and the second fiber type 11 to be identical, for example, and for only the third fiber type 12 to differ therefrom in terms of at least one property.

### EXAMPLE 4

A fourth example of a construction of the tier 8 or 9, respectively, of a textile planar structure is illustrated by means of a schematic cross section through the tier 8 or 9, respectively, in FIG. 7.

In the case of the fourth example, the first fiber type 10 and the second fiber type 11 differ from one another at least in terms of the cross-sectional shape thereof. While the first fiber type 10 has a substantially round cross section and can be formed by a round wire, for example, the second fiber type 11 has another cross-sectional profile, in the specific case illustrated an oval cross section, for example. While a round and an oval cross-sectional profile are illustrated for the different fiber types in FIG. 7, other combinations are also possible. In particular, more than two different fiber types can also be used, for example. Furthermore, the fiber types can also additionally differ from one another in terms of one or more further properties, said fiber types in particular also potentially being formed from different materials, for example.

### EXAMPLE 5

A fifth example of a construction of the tier 8 or 9, respectively, of a textile planar structure is illustrated by means of a schematic cross section through the tier 8 or 9, respectively, in FIG. 8.

In the case of the fifth example, the first fiber type 10 is again formed by round wire, but the fibers of the second fiber type 11 are in each case composed of a plurality of individual filaments. In this case it is additionally also possible, for example, for the individual filaments of the second fiber type 11 to comprise a plurality of different types of filaments which differ from one another in terms of the material, the cross-sectional profile, the surface structure, and/or the thickness, for example.

Also in the case of the fifth example, the first fiber type 10 and the second fiber type 11 can be composed of the same material, for example, or else be formed from different materials.

In the case of a modification it is also possible, for example, for the first fiber type 10 to be composed of a plurality of individual filaments. Moreover, it is furthermore possible for one or a plurality of further fiber types to be additionally used in the tier 8 or 9, respectively.

### Refinements and Modifications

In the production of the textile planar structure for the tier 8 or 9, respectively, the proportions between the first fiber type 10 and the second fiber type 11 (and optionally also of further fiber types) can be varied in a simple manner. In particular, these ratios can also be mutually varied in spatial terms so as to provide different regions having in each case adapted properties in a targeted manner.

In the construction of the porous fuel treatment element 5, a plurality of tiers of the hybrid textile planar structures described can be combined with one another both within one of the regions B1, B2, B3 of the fuel treatment element 5 as well as between said regions. Furthermore, it is also possible for the hybrid textile planar structures described to be combined with tiers from conventional textile planar structures.

In the case of a production of the textile planar structure by way of needles such as is the case in particular in a knitting method, for example, it is possible, for example, for different materials to run into the needles in an alternating manner, for different materials to run simultaneously into different needles, etc.

Furthermore, it is possible, for example, for different materials to be twisted together (to be doubled), or for different materials that have already been combined so as to form a linear textile planar structure such as, for example, a twisted yarn, a strand, etc., to be utilized for the configuration of the textile planar structure.

The combination of different fiber types can consequently be performed inter alia by:
A combination of fibers from different materials (for example, metal and rock fiber, synthetic fiber, glass fiber, etc., or a combination of two metal wires, synthetic fibers, etc., of different compositions).
A combination of different fibers from the same material (for example, different thicknesses, cross-sectional profiles, surface structures, etc.).
Combinations in which the fibers differ from one another in a plurality of properties (for example, in terms of material and the cross-sectional shape, etc.).

The porous fuel treatment element 5 can furthermore be brought into the desired shape by way of various methods, for example in particular by cutting, punching, laser cutting, trimming, turning over, and optionally by stitching free ends, winding up, folding, pressing, rolling and/or calendering. The porous fuel treatment element 5 can furthermore be inherently solidified by, for example, sintering, welding, brazing/soldering, or the like, and can optionally also be connected to adjacent components or bodies by way of one of these methods.

The at least one tier 8 or 9, respectively, from different fiber types described can be used at various locations of the fuel treatment element 5 so as to set the fuel intake, the fuel distribution and conveying, a temporary storage of the fuel, a homogenization of the fuel flow, a preheating of the fuel, and/or the evaporation of the fuel in a targeted manner.

1. A porous fuel treatment element for an evaporation burner, having
at least one first tier of a textile planar structure which is formed from a plurality of fibers,
wherein the fibers in the first tier comprise at least two different fiber types which differ in a material, a cross-section profile, a surface structure, or a thickness.

2. The porous fuel treatment element as claimed in claim 1, wherein the textile planar structure is a felt, a non-woven fabric, a needled mat, a scrim, a woven fabric, a warp/weft-knitted fabric, a knitted fabric, or a braided fabric.

3. The porous fuel treatment element as claimed in claim 1, wherein the fibers of the at least one tier comprise at least two different materials.

4. The porous fuel treatment element as claimed in claim 1, wherein at least one fiber type is composed of a plurality of individual filaments.

5. A porous fuel treatment element as claimed in claim 4, wherein the plurality of individual filaments comprises at least two different materials.

6. The porous fuel treatment element as claimed in claim 1, wherein at least one fiber type comprises metal wire.

7. The porous fuel treatment element as claimed in claim 1, wherein at least one fiber type comprises glass fiber, rock fiber, synthetic fiber, or ceramic fiber.

8. The porous fuel treatment element as claimed in claim 1, wherein the at least one fiber type comprises rock fiber.

9. The porous fuel treatment element as claimed in claim 1, wherein the at least two fiber types comprise at least metal wire and at least one of glass fiber, rock fiber, synthetic fiber, and ceramic fiber.

10. The porous fuel treatment element as claimed in claim 1, wherein the porous fuel treatment element comprises at least one further tier of a textile planar structure which a construction, of the structure, a material, or a thickness differs from the first tier.

11. The porous fuel treatment element as claimed in claim 1, wherein the fibers of the at least one further tier at least two different fiber types which differ in a material, a cross-sectional shape, a structure, or a thickness.

12. The porous fuel treatment element as claimed in claim 1, wherein the fibers in the first tier 4 comprise at least fibers having a first cross-sectional shape and fibers having a second cross-sectional shape.

13. A mobile heating apparatus having an evaporation burner which has a porous fuel treatment element as claimed in claim 1.
